(19) United States
(12) Patent Application Publication
(10) Pub. No.: US 2014/0036534 A1
(43) Pub. Date: Feb. 6, 2014

(54) OPTICAL SHEET GUIDE MEMBER, AND BACKLIGHT UNIT HAVING THE OPTICAL SHEET GUIDE MEMBER

(71) Applicant: SAMSUNG DISPLAY CO., LTD., Yongin-City (KR)

(72) Inventor: Wee-Joon JEONG, Seoul (KR)

(73) Assignee: SAMSUNG DISPLAY CO., LTD., Yongin-City (KR)

(21) Appl. No.: 13/804,454

(22) Filed: Mar. 14, 2013

(30) Foreign Application Priority Data
Aug. 2, 2012 (KR) 10-2012-0084954

(51) Int. Cl. F21V 8/00

(52) U.S. Cl. CPC G02B 6/0055
USPC 362/611

(57) ABSTRACT

A backlight unit includes a light source which supplies light; a light guide which transmits the light; an optical sheet on the light guide, and including a guide member extending from a side surface of the optical sheet; and a reflection sheet under the light guide. The reflection sheet reflects the light toward the optical sheet and includes a protrusion guide member which extends from a side surface of the reflection sheet and toward the light guide. The guide member of the optical sheet is coupled to the protrusion guide member of the reflection sheet, and restricts movement of the optical sheet.

This application claims priority to Korean Patent Application No. 10-2012-0084954 filed on Aug. 2, 2012, and all the benefits accruing therefrom under 35 U.S.C. §119, the entire contents of which are incorporated herein by reference.

### BACKGROUND

(a) Field

The invention relates to a backlight unit.

(b) Description of the Related Art

Based on semiconductor technology which has been rapidly developed, demand for a flat panel display having more improved performance due to a small size and a light weight has explosively increased.

A liquid crystal display (“LCD”) which has been in the spotlight among the flat panel displays has merits of a small size, a light weight, low power consumption, and the like. Accordingly, the liquid crystal display has gradually gained more attention as an alternative display capable of overcoming demerits of a known cathode ray tube (“CRT”) and is used in a number of information processing devices where display devices are required.

In general, the liquid crystal display has a liquid crystal material between upper and lower panels of a liquid crystal panel. For example, the upper panel may include a common electrode, a color filter and the like, and the lower panel may include a thin film transistor and a pixel electrode. Different electrical potentials are applied to the pixel electrode and the common electrode of the liquid crystal panel of the liquid crystal display. Accordingly, the liquid crystal display generates an electric field and changes alignment of liquid crystal molecules of the liquid crystal material so as to control transmittance of light, thereby displaying images.

The liquid crystal panel of the liquid crystal display is a light receiving element which is not self-emitting, such that a backlight unit for supplying light to the liquid crystal panel is provided below the liquid crystal panel. The backlight unit includes a lamp, a light guide plate, a reflective sheet, an optical sheet and the like.

The optical sheet is positioned on the light guide plate, and a position fixing member which fixes a position and restricts movement of the optical sheet may be additionally included. As the position fixing member, an additional fixing member is disposed at a chassis (for example, a bottom chassis) and the optical sheet is fixed on the light guide plate.

However, since the additional fixing member at the chassis is accommodated in an area or width of the liquid crystal display and/or the backlight unit surrounding the optical sheet, reducing such area or width may be undesirably limited. This area or width surrounding the optical sheet may be referred to as a bezel of the backlight unit or the liquid crystal display.

Also, to form the additional fixing member at the chassis, a shape of the additional fixing member must be added to a mold of the chassis such that there are drawbacks since a manufacturing process is complicated, a manufacturing time is increased and a cost is increased.

### SUMMARY

One or more exemplary embodiment of the invention provides a backlight unit which fixes an optical sheet with a low manufacturing cost and process time.

An exemplary embodiment of a backlight unit according to the invention includes: a light source which supplies light; a light guide which transmits the light; an optical sheet on the light guide, and including a fixing member disposed at a side surface of the optical sheet; and a reflection sheet under the light guide. The reflection sheet reflects the light toward the optical sheet and includes a protrusion guide member which extends from a side surface of the reflection sheet and toward the light guide. The fixing member of the optical sheet is coupled to the protrusion guide member of the reflection sheet, and restricts movement of the optical sheet.

The fixing member of the optical sheet may comprise a protrusion guide member extending from the side surface of the optical sheet.

The fixing member of the optical sheet may further comprise a groove disposed between the protrusion guide members of the guide member.

A guide member unit restricts the movement of the optical sheet, and may include one protrusion guide member of the reflection sheet between two fixing members of the optical sheet.

The backlight unit may further include an adhesive member between a side surface of the light guide and the protrusion guide member of the reflection sheet, where the adhesive member couples the light guide and the protrusion guide member to each other.

A guide member unit restricts the movement of the optical sheet, and may include one fixing member of the optical sheet between two protrusion guide members of the reflection sheet.

The reflection sheet may further include a main body, and a bent portion which connects the protrusion guide member and the main body.

The reflection sheet may further include an opening at the bent portion of the reflection sheet, where the protrusion guide member and the main body are separated from each other by the opening.

The main body and the protrusion guide member may be separated by a predetermined distance.

The protrusion guide member may include a same material as the reflection sheet.

The reflection sheet may further include a protrusion guide member extension which extends from a distal end of the protrusion guide member, and the protrusion guide member extension overlaps the light guide.

The protrusion guide member extension may overlap the optical sheet.

The backlight unit may further include a first adhesive member between a side surface of the light guide and the protrusion guide member of the reflection sheet, where the first adhesive member couples the light guide and the protrusion guide member to each other.

The reflection sheet may further include a protrusion guide member extension, and the backlight unit may further include a second adhesive member between an upper surface of the optical sheet and the protrusion guide member extension. The second adhesive member may couple the optical sheet and the protrusion guide member extension to each other.

A guide member restricts the movement of the optical sheet, and includes the protrusion guide member of the reflection sheet and the fixing member of the optical sheet. The backlight unit may include two guide member units.

One of the two guide member units may be positioned at a first side of the light guide, and the other of the two guide member units may be positioned at a second side opposing the first side of the light guide.

The light source may be positioned at a side of the light guide excluding the guide member units.

The protrusion guide member of the reflection sheet may be spaced apart from the side surface of the optical sheet where the guide member is disposed

The protrusion guide member of the reflection sheet may contact the side surface of the optical sheet where the guide member is disposed.

As described above, in one or more exemplary embodiment, the optical sheet may be easily fixed through the protrusion guide member of the reflection sheet and a corresponding guide member of the optical sheet, such that a bezel of a liquid crystal display and/or the backlight unit may be narrows.

### BRIEF DESCRIPTION OF THE DRAWINGS

The above and other features of this disclosure will become more apparent by describing in further detail exemplary embodiments thereof with reference to the accompanying drawings, in which:

FIG. 1 is an exploded perspective view of an exemplary embodiment of a liquid crystal display according to the invention.

FIG. 2 is an enlarged perspective view of an exemplary embodiment of a guide member unit of a backlight unit according to the invention.

FIG. 3 is a partial cross-sectional view of an exemplary embodiment of a liquid crystal display including the guide member unit of FIG. 2, according to the invention.

FIG. 4 is a schematic top plan view of an exemplary embodiment of a position of a fixing member of an optical sheet according to the invention.

FIG. 5 is a perspective view of another exemplary embodiment of a fixing member of a reflection sheet according to the invention.

FIG. 6 is a partial cross-sectional view of an exemplary embodiment of a liquid crystal display including the fixing member of FIG. 5, according to the invention.

FIG. 7 and FIG. 9 are perspective views of still another exemplary embodiment of a guide member of a reflection sheet according to the invention.

FIG. 8 is a partial cross-sectional view of an exemplary embodiment of a liquid crystal display including the guide member of FIG. 7 and FIG. 9, according to the invention.

FIG. 10 is a perspective view of another exemplary embodiment of a guide member unit of a backlight unit according to the invention.

FIG. 11 is a schematic top plan view of another exemplary embodiment a position of a fixing member of an optical sheet according to the invention.

### DETAILED DESCRIPTION

The invention will be described more fully hereinafter with reference to the accompanying drawings, in which exemplary embodiments of the invention are shown. As those skilled in the art would realize, the described embodiments may be modified in various different ways, all without departing from the spirit or scope of the invention.

In the drawings, the thickness of layers, films, panels, regions, etc., are exaggerated for clarity. Like reference numerals designate like elements throughout the specification. As used herein, connected may refer to elements being physically and/or electrically connected to each other. Like numbers refer to like elements throughout. As used herein, the term “and/or” includes any and all combinations of one or more of the associated listed items.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “lower,” “under,” “above,” “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” or “under” relative to other elements or features would then be oriented “above” relative to the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the invention will be described in detail with reference to the accompanying drawings.

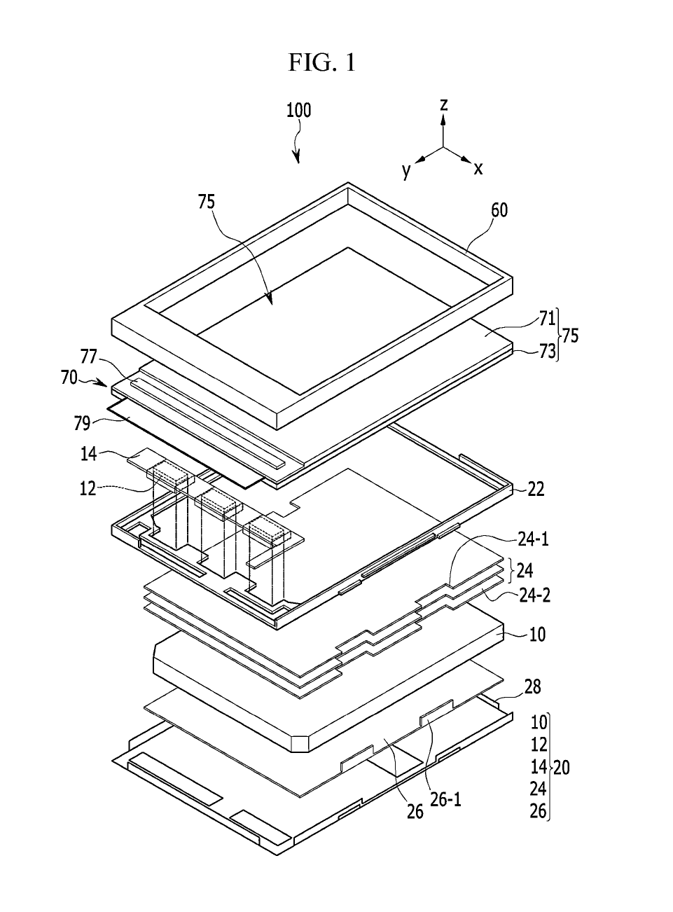

Now, an exemplary embodiment of a backlight unit according to the invention will be described with reference to FIG. 1 to FIG. 4.

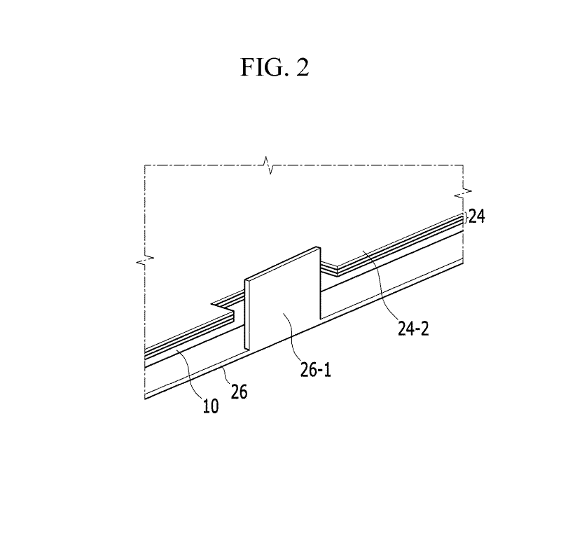

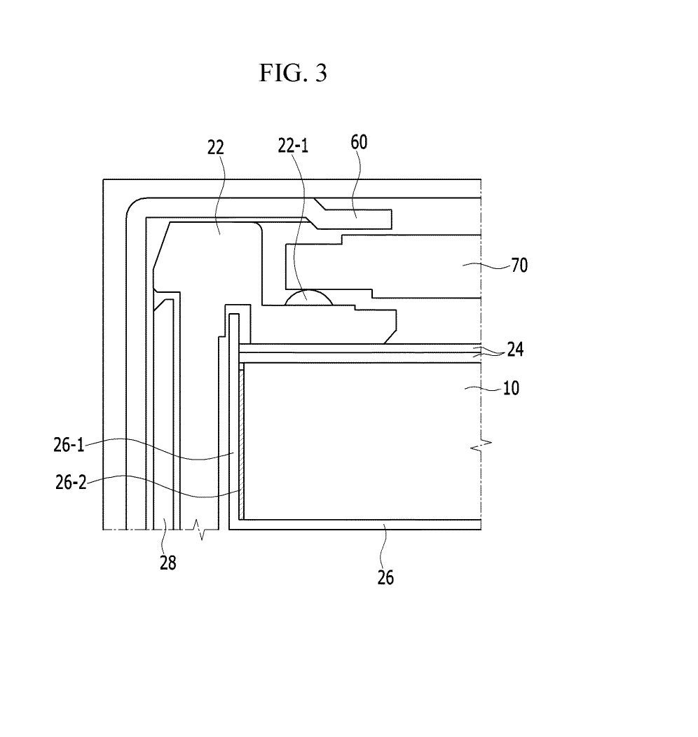

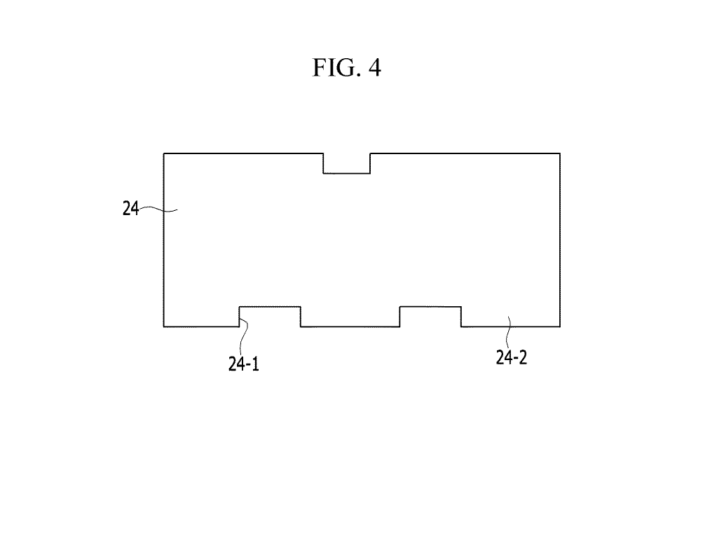

FIG. 1 is an exploded perspective view of an exemplary embodiment of a liquid crystal display according to the invention, FIG. 2 is an enlarged perspective view of an exemplary embodiment of a guide member unit of a backlight unit according to the invention, FIG. 3 is a partial cross-sectional view of an exemplary embodiment of a liquid crystal display including the guide member unit of FIG. 2 according to the invention, and FIG. 4 is a schematic top plan view of an exemplary embodiment of a position of a fixing member of an optical sheet according to the invention.

An exemplary embodiment of a liquid crystal display 100 according to the invention shown in FIG. 1 includes a backlight unit 20 supplying light and a liquid crystal panel assembly 70 displaying an image using the supplied light. In addition, the liquid crystal display 100 may further include a top chassis 60, a mold frame 22 and a bottom chassis 28 to fix the backlight unit 20 and/or the liquid crystal panel assembly 70. In an exemplary embodiment as illustrated in FIG. 1, the liquid crystal display 100 may be substantially frame shaped. For orientation purposes, a Cartesian coordinate system may be used where a first (long) side of the liquid crystal display 100 extends along a Y-axis direction, and a second (short) side of the liquid crystal display 100 extends along an X-axis direction, where the Y-axis is substantially perpendicular to the X-axis, and a Z-axis direction is substantially perpendicular to both the X and Y axes.

The backlight unit 20 shown in FIG. 1 provides light to the liquid crystal panel assembly 70, and the liquid crystal panel assembly 70 positioned on the backlight unit 20 controls the light supplied by the backlight unit 20 to express a color such as a gray, thereby displaying an image.

The liquid crystal panel assembly 70 includes a liquid crystal panel 75, an integrated circuit (“IC”) chip 77 and a flexible printed circuit (“FPC”) board 79.

The liquid crystal panel 75 includes a thin film transistor (“TFT”) array panel 73 including a plurality of TFTs, an upper panel 71 facing the TFT array panel 73, and liquid crystal (not shown) between the panels. The TFT array panel 73 and the upper panel 71 may include one or more pixels which correspond to each other, respectively. The IC chip 77 may be mounted on the TFT array panel 73 to control the liquid crystal panel 75, but is not limited thereto or thereby.

The TFT array panel 73 may include a matrix of TFTs and a pixel electrode. A TFT may include a source terminal connected to a data line (not shown), and a gate terminal connected a gate line (not shown), on a transparent insulation substrate. The TFT may further include a drain terminal connected to the pixel electrode. The pixel electrode may include transparent indium tin oxide (“ITO”) as a conductive material.

Where the data line and gate line of the liquid crystal panel 75 are connected to the FPC board 79 and an electric signal from the FPC board 79 is input to the liquid crystal panel 75, the electric signal is transmitted to the source terminal and the gate terminal of the TFT. The electrical signal, otherwise referred to as a driving signal, may include a scanning signal and an image signal. In one exemplary embodiment, the TFT is turned on or turned off according to the scanning signal applied to the gate terminal of the TFT via the gate line such that the image signal applied to the source terminal of the TFT via the data line is transmitted to the drain terminal of the TFT or blocked. The liquid crystal panel 75 receives the driving signal from the FPC board 79 and the driving signal is respectively applied to the data line and the gate line of the liquid crystal panel 75.

The upper panel 71 is disposed on and facing the TFT array panel 73. In one exemplary embodiment, the upper panel 71 is a panel including one or more color filters, such as red, green and blue (“RGB”) color filters which may be formed through a thin film process, to thereby realize predetermined colors as the light passes therethrough. A common electrode including ITO may be deposited on an entire surface of the color filter. When electric power is applied to the gate and source terminals of the TFT to turn on the TFT, an electric field is formed between the pixel electrode of the TFT array panel 73 and the common electrode of the upper panel 71. An arrangement angle of the liquid crystal between the TFT array panel 73 and the upper panel 71 is changed by the electric field, and the light transmittances of the pixels are individually varied in accordance with the arrangement angles of the liquid crystal in the pixels, thereby obtaining a desired image.

The FPC board 79 generates the image signal and the scanning signal as signals to drive the liquid crystal display 100, and a plurality of timing signals used to apply the driving signals at an appropriate timing. The FPC board 79 applies the scanning signal and the image signal to the gate line and the data line of the liquid crystal panel 75, respectively.

An exemplary embodiment of the structure of the liquid crystal panel 75 according to the invention has been described above. However, different from the above exemplary embodiment, various exemplary embodiments of liquid crystal panels 75 may be used the liquid crystal display 100. In one exemplary embodiment, for example, the common electrode and the color filter above-described in the upper panel 71, may be instead in the TFT array panel 73. Also, an additional printed circuit board (“PCB”) may be further included, and the PCB and the TFT array panel 71 may be connected by the FPC board 79.

The backlight unit 20 uniformly provides light to the liquid crystal panel 75. The backlight unit 20 is provided under the liquid crystal panel assembly 70 and is received on the bottom chassis 28.

The backlight unit 20 includes a light emitting diode (“LED”) 12 (indicated by a dotted line), a substrate 14 supplying power to the LED 12 and on which the LED 12 is mounted, a light guide 10 such as a light guide plate guiding light emitted from the LED 12 and supplying the guided light to the liquid crystal panel assembly 70, a reflection sheet 26 positioned under and overlapping substantially a whole surface of the light guide 10, and reflecting light, and an optical sheet 24 receiving a light having a luminance characteristic from the LED 12 and providing the light having the luminance characteristic to the liquid crystal panel assembly 70. The LED 12 is fixed to the mold frame 22, and generates and supplies light to the liquid crystal panel assembly 70. The backlight unit 20 may include a plurality of LEDs 12. In the illustrated exemplary embodiment, the LED 12 is used as a light source, however, is not limited thereto, and a fluorescent lamp such as cold cathode fluorescent lamp (“CCFL”) may alternatively be used.

The liquid crystal display 100 may include a display area, and a non-display area excluding the display area. The optical sheet 24 may be disposed in the display area of the liquid crystal display 100, but is not limited thereto or thereby. An area or width surrounding the optical sheet 24 may be referred to as a bezel of the backlight unit 20 or of the liquid crystal display 100. In a plan view of the liquid crystal display 100, the bezel may include portions of an area taken from an edge of the optical sheet 24 or other internal component of the liquid crystal panel assembly 70 or the backlight unit 20, and extending to an outermost edge of the liquid crystal display 100.

Although not shown in FIG. 1, an inverter board as a power supplying PCB and a signal converting PCB may be provided on a rear surface of the bottom chassis 28. The inverter board transforms external power with a predetermined voltage level and provides the transformed power to the LED 12, and the signal conversion PCB is connected to the FPC 79 and converts an analog data signal to a digital data signal and provides the converted signal to the liquid crystal panel 75.

The top chassis 60 is provided on the liquid crystal panel assembly 70 and restricts movement of the liquid crystal panel assembly in a direction away from the bottom chassis 28, to reduce or effectively prevent the liquid crystal panel assembly 70 from breaking away from the bottom chassis 28 when the FPC board 79 is bent outside the mold frame 22. Although not shown in FIG. 1, a front case and a rear case are respectively positioned on the top chassis 60 and under the bottom chassis 28, and the front and rear cases are combined with each other thereby forming the liquid crystal display 100.

The optical sheet 24 is positioned on the light guide 10 and a position thereof is fixed relative to other elements of the liquid crystal display 100. However, according to an alternative exemplary embodiment, the optical sheet 24 may be positioned so as to be movable by a predetermined distance or level. If the optical sheet 24 undesirably moves from the position of the predetermined level, light provided from the backlight unit 20 does not pass through the optical sheet 24 and is not provided to the liquid crystal panel 75.

The fixing of the optical sheet 24 will be described with reference to FIG. 2 and FIG. 3.

Referring to FIG. 2 and FIG. 3, the fixing of the optical sheet 24 is realized by a fixing member, that is, a protrusion guide member 26-1 protruded from a main body of the reflection sheet 26 and toward an upper portion of the light guide 10, e.g., toward a viewing side of the liquid crystal display 100 in a Z-axis direction. The reflection sheet 26 may include a plurality of protrusion guide members 26-1 extended from the main body. The protrusion guide member 26-1 includes and is formed with a same material as the reflection sheet 26. In one exemplary embodiment, the protrusion guide member 26-1 and the main body may form a continuous, single and unitary member, such that the protrusion guide member 26-1 is bent at a side surface of the light guide 10, and is protruded to the upper portion of the light guide 10. In the illustrated exemplary embodiment, a planar shape of the protrusion guide member 26-1 is square, however, the protrusion guide member 26-1 may have various shapes.

Referring to FIG. 2 and FIG. 3, the optical sheet 24 has a fixing member. The fixing member comprises a protrusion guide member 24-2 corresponding to the protrusion guide member 26-1 of the reflection sheet 26 and a groove 24-1 disposed between the protrusion guide members. The optical sheet 24 may include a plurality of protrusion guide members 24-2. One or more protrusion guide member 24-2 may be disposed on a side of the optical sheet 24, such as at each of two opposing sides. A number of the protrusion guide members 24-2 on one side may be the same or different from a number of the protrusion guide members 24-2 on the opposing side. The protrusion guide member 24-2 is positioned at a side surface of the optical sheet 24 and has a structure that is protruded toward an outside of the optical sheet 24. The side surface of the optical sheet 24 may be considered the edge of a main body of the optical sheet 24 from which the protrusion guide member 24-2 protrudes. The optical sheet 24 may further include one or more groove 24-1 defined by adjacent protrusion guide members 24-2. The protrusion guide members 24-2 and the grooves 24-1 may alternate in the Y-axis direction of the liquid crystal display 100. The groove 24-1 of the optical sheet 24 may correspond to and be aligned with a protrusion guide member 26-1 of the reflection sheet 26.

Referring to FIG. 2 and FIG. 3, the protrusion guide member 26-1 of the reflection sheet 26 is coupled to the protrusion guide member 24-2 of the optical sheet 24 thereby forming a guide member unit fixing the optical sheet 24. The guide member unit may include only one protrusion guide member 26-1 and only one protrusion guide member 24-2, but is not limited thereto or thereby. The coupling of the protrusion guide member 26-1 of the reflection sheet 26 and the protrusion guide member 24-2 of the optical sheet 24 restricts movement of the optical sheet 24 in the Y-axis direction. A plurality of protrusion guide members 26-1 of the reflection sheet 26 and a plurality of the protrusion guide members 24-2 of the optical sheet 24 may alternate in the Y-axis direction.

The guide member unit includes the protrusion guide member 26-1 and the protrusion guide member 24-2, and referring to FIG. 1 and FIG. 2, in the illustrated exemplary embodiment, the guide member unit further includes the groove 24-1. That is, in the exemplary embodiment of FIG. 1 and FIG. 2, the groove 24-1 between adjacent protrusion guide members 24-2 of the optical sheet 24 and one protrusion guide member 26-1 of the reflection sheet 26 are coupled to each other and form a guide member unit which fixes the optical sheet 24. The guide member unit may include only one protrusion guide member 26-1 and only two protrusion guide members 24-2, but is not limited thereto or thereby.

Referring to FIG. 2, the protrusion guide member 26-1 and the side surface of the optical sheet 24 are separated by a predetermined interval. However referring to FIG. 3, the protrusion guide member 26-1 may contact the side surface of the optical sheet 24. The protrusion guide member 26-1 of the reflection sheet 26 may be attached to a side surface of the light guide 10 such as by an adhesive member 26-2, thereby promoting or maintaining the protrusion guide member 26-1 in contact with the side surface of the optical sheet 24.

Referring to FIG. 3, the top chassis 60, the mold frame 22 and the bottom chassis 28 in FIG. 1 are coupled to each other and fix the backlight unit 20 and the liquid crystal panel assembly 70 respectively therebetween.

Also, in FIG. 3, the liquid crystal panel assembly 70 does not directly contact the mold frame 22, but is instead supported by a damping member 22-1 of the mold frame 22. In an exemplary embodiment, the damping member 22-1 may have a square frame structure according to the liquid crystal panel assembly 70, and/or may include a plastic material such as silicon.

In FIG. 3, a thickness of the light guide 10 taken in the Z-axis direction is illustrated as having a greater thickness than that of the liquid crystal panel assembly 70, however, is not limited thereto or thereby. Referring to FIG. 1 and FIG. 4, the guide member unit of the backlight unit 20 may include three grooves 24-1 of the optical sheet 24. The backlight unit 20 may include one groove 24-1 for each protrusion guide member 26-1 of the reflection sheet 26, and the grooves 24-1 and the protrusion guide members 26-1 are coupled to each other.

As described, when the backlight unit 20 includes the guide member unit, movement of the optical sheet 24 is restricted in a horizontal (e.g., Y-axis) direction because of the coupling of the groove 24-1 with the protrusion guide member 26-1, and movement of the optical sheet 24 is restricted in a vertical (e.g., X-axis) direction because of the protrusion guide member 26-1 of the reflection sheet 26, thereby confirming the fixing of the optical sheet 24.

Differently from FIG. 4, the backlight unit 20 may include two guide member units at a first side of the optical sheet 24 and the light guide 10, and two guide member units may be at a second side opposite to (e.g., facing) the first side of the optical sheet 24 and the light guide 10. However, the invention is not limited thereto and may include more or less than two guide member units on the opposing sides of the light guide unit 10.

When a guide member unit is at opposing sides of the light guide 10 as shown in FIG. 4, the light source such as the LED 12 may be positioned at the side of the light guide 10 without the guide member unit.

Also, the backlight unit 20 includes a plurality of protrusion guide members 26-1, the adhesive member 26-2 may not be necessary to fix the light guide 10 and the protrusion guide member 26-1 to each other. When the protrusion guide members 26-1 are attached to the light guide 10, the optical sheet 24 and/or the protrusion guide member 26-1 may be deformed by heat from the light source such that the optical sheet 24 and/or the protrusion guide member 26-1 become detached and undesirably form a margin.

The backlight unit 20 may include one or more optical sheets 24. The exemplary embodiment of FIG. 1 shows three optical sheets 24, but should not be limited thereto or thereby. When there is more than one optical sheet 24, the protrusion guide member 24-2 may be in all optical sheets 24 and aligned with each other in the liquid crystal display 100.

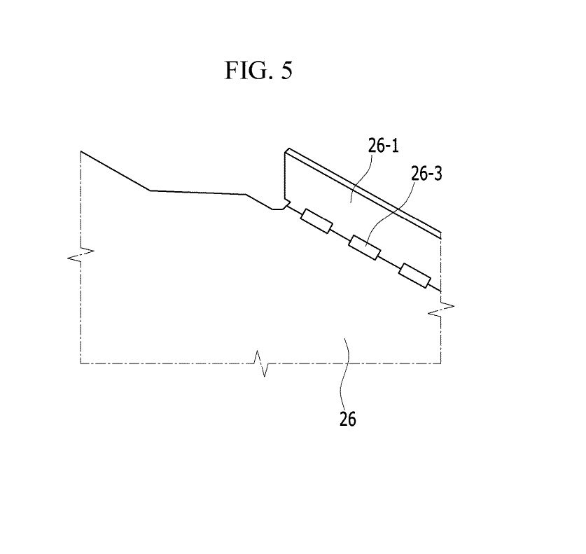

Next, alternative exemplary embodiments of a structure of a guide member unit according to the invention will be described with reference to FIG. 5 to FIG. 10.

FIG. 5 is a perspective view of another exemplary embodiment of a fixing member of a reflection sheet according to the invention.

In the exemplary embodiment of FIG. 5, a protrusion guide member 26-1 of a reflection sheet 26 has an opening 26-3 at a bent portion The bent portion is a portion where the main body of the reflection sheet 26 and the protrusion guide member 26-1 meet each other. The opening 26-3 may allow easy bending of the protrusion guide member 26-1 from the main body of the reflection sheet 26. A size or dimension such as a width or a length of the opening 26-3 may be changed according to a size of the protrusion guide member 26-1 and/or the material of the reflection sheet 26.

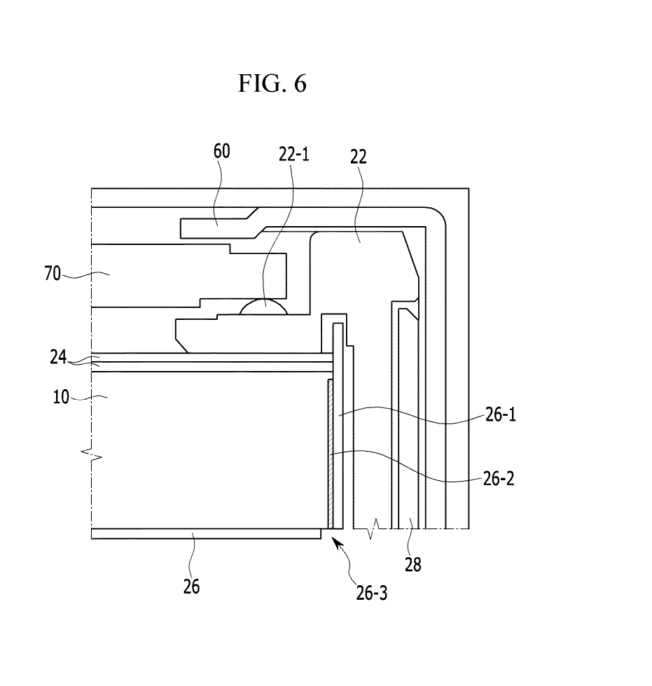

FIG. 6 is a partial cross-sectional view of an exemplary embodiment of a liquid crystal display including the fixing member of FIG. 5 according to the invention.

The cross-sectional view of FIG. 6 corresponds to the cross-sectional view of FIG. 3, except that the protrusion guide member 26-1 is separated from the main body of the reflection sheet 26 at the opening 26-3. In the illustrated exemplary embodiment, the protrusion guide member 26-1 is connected to the main body of the reflection sheet 26 at portions of the reflection sheet 26 excluding the opening 26-3, and is fixed to the side surface of the light guide 10 by the adhesive member 26-2.

When the reflection sheet 26 includes a plurality of protrusion guide members 26-1, portions of the protrusion guide members 26-1 may be connected or fixed to the reflection sheet 26, and other portions of the protrusion guide members 26-1 may be fixed to the side of the light guide 10 by the adhesive member 26-2.

Even when portions of the protrusion guide members 26-1 are fixed to the side of the light guide 10 by the adhesive member 26-2 as illustrated in FIG. 6, deformation of the optical sheet 24 and/or the protrusion guide member 26-1 by long exposure to heat from the light source may be reduced or effectively prevented.

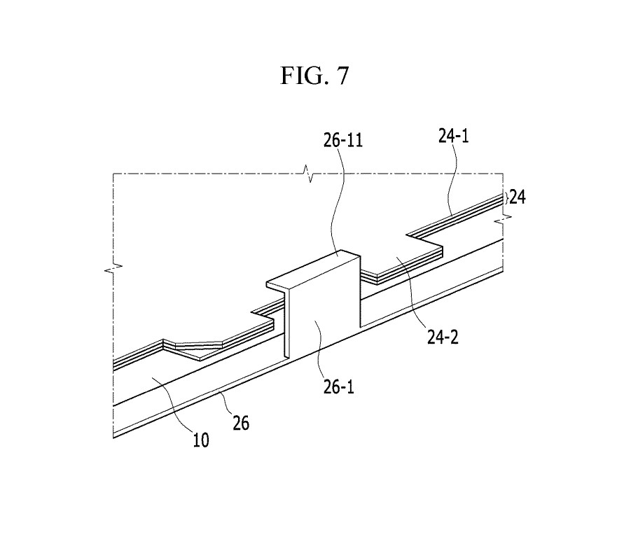

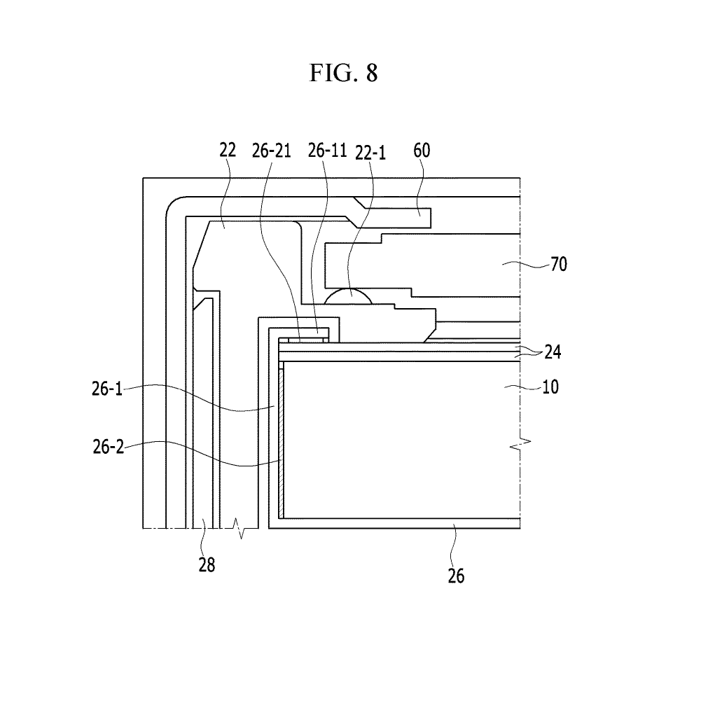

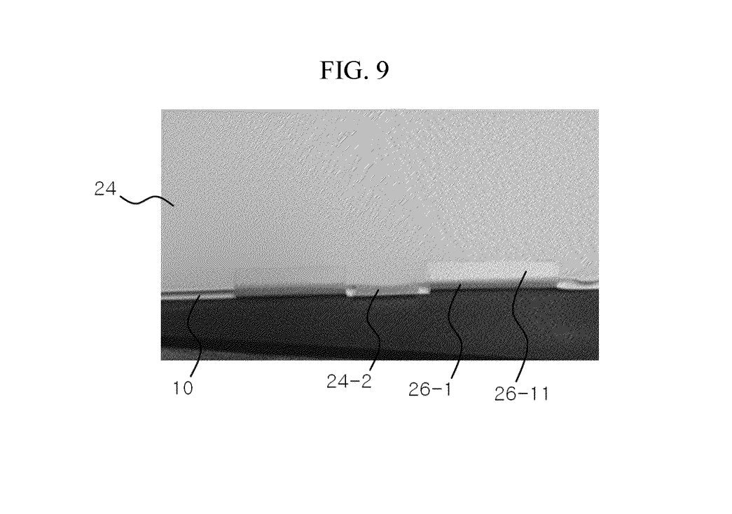

FIG. 7 and FIG. 9 are perspective views of a still another exemplary embodiment of a guide member of a reflection sheet according to the invention. FIG. 8 is a partial cross-sectional view of a liquid crystal display including the guide member of the reflection sheet of FIG. 7 and FIG. 9 according to the invention.

The protrusion guide member 26-1 of the reflection sheet 26 shown in FIG. 7 to FIG. 9 includes an additional protrusion guide member extension 26-11. The protrusion guide member extension 26-11 extends from a distal end of the protrusion guide member 26-1 and overlaps the light guide 10 and the optical sheet 24. In one exemplary embodiment, protrusion guide member extension 26-11, the protrusion guide member 26-1 and the main body may form a continuous, single and unitary member. The protrusion guide member extension 26-11 may be substantially parallel to the main body of the reflection plate 26, but is not limited thereto or thereby.

The protrusion guide member extension 26-11 may reduce or effectively prevent movement of the optical sheet 24 in the Z-axis direction and toward the liquid crystal panel assembly 70.

As shown in FIG. 8, the protrusion guide member extension 26-11 may be coupled to the optical sheet 24 such as by an additional adhesive member 26-21. In one exemplary embodiment, the additional adhesive member 26-21 and the adhesive member 26-2 are continuous with and connected to each other thereby being integrally formed as a single, unitary, indivisible unit, but are not limited thereto or thereby.

FIG. 9 shows a structure in which the reflection sheet 26 including the protrusion guide member 26-1 and the protrusion guide member extension 26-11, the light guide 10, and the optical sheet 24 including the protrusion guide member 24-2 are coupled with each other to collectively form a guide member unit of the backlight unit 20. However, the elements of the structure in FIG. 9 are not coupled to each other by an adhesive member.

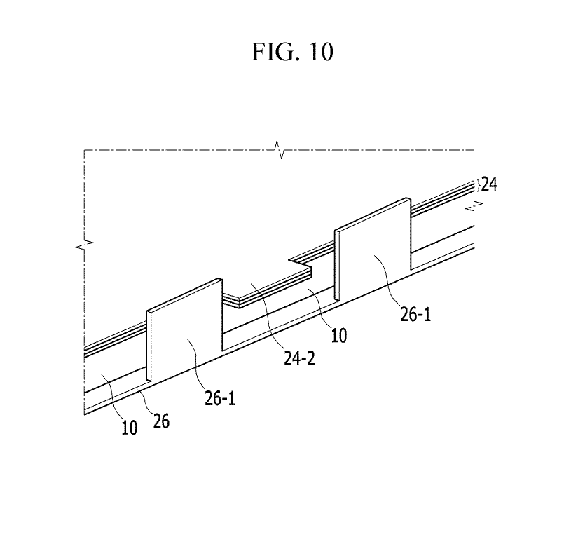

Also, as illustrated in the exemplary embodiment of FIG. 9, the backlight unit 20 includes two protrusion guide members 26-1, and one protrusion guide member 24-2 is between the two protrusion guide members 26-1, as further described in detail with respect to FIG. 10.

FIG. 10 is a perspective view of another exemplary embodiment of a guide member unit of a backlight unit according to the invention. According to FIG. 10, another exemplary embodiment of the guide member unit includes one protrusion guide member 24-2 of the optical sheet 24 at a side of the light guide 10 and two protrusion guide members 26-1 of the reflection plate positioned at opposing sides of the one protrusion guide member 24-2. A gap between the two adjacent protrusion guide members 26-2 corresponds to and is aligned with the protrusion guide member 24-2. That is, in the exemplary embodiment of FIG. 10, since the optical sheet 24 includes one protrusion guide member 24-2, the optical sheet 24 does not include the groove 24-1. The guide member unit may include only one protrusion guide member 24-2 and only two protrusion guide members 26-1, but is not limited thereto or thereby.

By the structure illustrated in FIG. 10, movement of the optical sheet 24 in right and left directions along the Y-axis may still be reduced or effectively prevented.

In FIG. 10, the protrusion guide members 26-1 are separated from side surfaces of the light guide 10 and the optical sheet 24 in the X-axis direction, however, are not limited thereto or thereby. In an alternative exemplary embodiment, one or more of the protrusion guide members 26-1 may contact the light guide 10 and/or the optical sheet 24, and one or more of the protrusion guide members 26-1 may be coupled to the side surface of the light guide 10 such as by an adhesive member.

The guide member unit may be at various positions with respect to sides of the light guide 10, in addition to the position shown in FIG. 4.

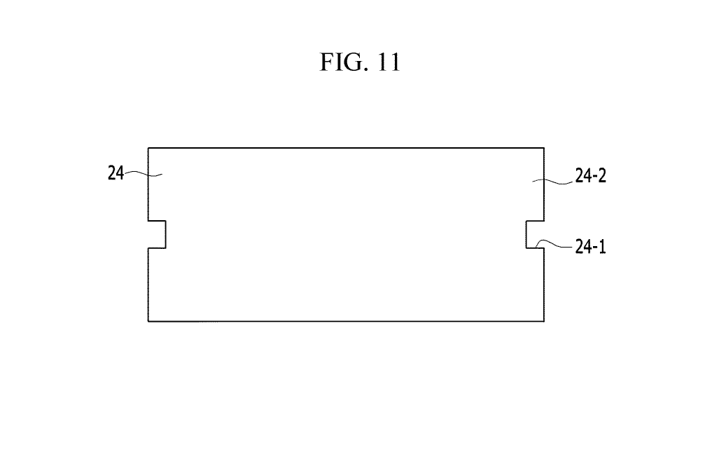

One among the various positions is shown in FIG. 11.

FIG. 11 is a schematic top plan view of another position of a fixing member of an optical sheet according to the invention.

Referring to FIG. 11, the guide member unit of the backlight unit 20 is at a total of two positions. That is, one groove 24-1 of the optical sheet 24 is at each of the long sides of the optical sheet 24, and the reflection sheet 26 includes one protrusion guide member 26-1 corresponding to each of the grooves 24-1. A protrusion guide member 26-1 and a groove 24-1 are respectively coupled to each other. The optical sheet 24 may include only one groove 24-1 on a side, such as on each of two opposing sides, but is not limited thereto or thereby. In alternative exemplary embodiments, the optical sheet may include more than one groove 24-1 on a side. A number of the grooves 24-1 on one side may be the same or different from a number of the grooves 24-1 on the opposing side.

Movement of the optical sheet 24 is reduced or effectively prevented in the long and short side directions because the grooves 24-1 of the two coupled guide member units are at opposing sides.

Where the optical sheet 24 is fixed by one or more of the exemplary embodiments of the guide member units, a width of the bezel of the liquid crystal display 100 may be reduced compared with a conventional liquid crystal display including a special structure at a chassis to fix an optical sheet. That is, in one or more exemplary embodiment of the invention, a planar area of the chassis structure is significantly larger than a width defined by a thickness of the bent reflection sheet 26, thereby achieving a narrow bezel.

Also, a reflection sheet 26 of the conventional liquid crystal display is further elongated such as owing to a wide bezel. Since one or more exemplary embodiment of the invention includes a narrow bezel, the manufacturing cost and the process time of forming (e.g., providing) a liquid crystal display are not increased.

In order to verify a fixing performance, a liquid crystal display 100 including an exemplary embodiment of the fixing structure of the optical sheet 24 of the backlight unit 20 as shown in FIG. 1 was manufactured, and the liquid crystal display 100 was dropped to measure separation of the optical sheet 24. The results are described in Table 1 below.

TABLE 1

| Dropping | | Experimental | Experimental | Experimental |
|---|---|---|---|---|
| height | Direction | Example 1 | Example 2 | Example 3 |
| 15 cm | Front surface | Pass | Pass | Pass |
| | Rear surface | Pass | Pass | Pass |
| | Upper surface | Pass | Pass | Pass |
| | Lower surface | Pass | Pass | Pass |
| | Left surface | Pass | Pass | Pass |
| | Right surface | Pass | Pass | Pass |
| 20 cm | Front surface | Pass | Pass | Pass |
| | Rear surface | Pass | Pass | Pass |
| | Upper surface | Pass | Pass | Pass |
| | Lower surface | Pass | Pass | Pass |
| | Left surface | Pass | Pass | Pass |
| | Right surface | Pass | Pass | Pass |
| 25 cm | Front surface | Pass | Pass | Pass |
| | Rear surface | Pass | Pass | Pass |
| | Upper surface | Pass | Pass | Pass |
| | Lower surface | Pass | NG | Pass |
| | Left surface | Pass | — | Pass |
| | Right surface | Pass | — | Pass |

Here, the front surface is a viewing side or screen side of the liquid crystal display where an image is displayed, and the rear surface is an opposite surface thereof. The upper surface is a surface of an upper side of the liquid crystal display when viewing the front surface, the lower surface is a surface of a lower side of the liquid crystal display when viewing the front surface, and the left surface and the right surface are surfaces of a left side and a right side of the liquid crystal display when viewing the front surface.

As shown in Table 1, three experimental examples of the liquid crystal display were manufactured, and the liquid crystal displays were dropped from heights of 15 centimeters (cm), 20 cm and 25 cm in each direction. As a result, at the heights of 15 cm and 20 cm, in all experimental examples, the optical sheet 24 is not separated such that there is no problem in fixing performance of the guide member unit according to the invention.

At the height of 25 cm, when the liquid crystal display is dropped in Experimental Example 2 with reference to the lower surface, and a condition of “NG” is generated. However, only the liquid crystal panel is broken, and the optical sheet 24 of the backlight unit 20 is not separated. That is, the fixing performance of the guide member unit according to the invention still passes. Therefore, the guide member unit according to the invention, maintains a position of the optical sheet 24 such that the optical sheet 24 remains fixed in a predetermined position.

It is noted that at the height of 25 cm, the liquid crystal panel is broken on the left surface and the right surface such that additional experiments are not performed and the result values are not provided.

Also, when using an optical sheet 24 for a relatively long time, the optical sheet 24 may be undesirably deformed or crumpled such as by heat from a light source within a backlight unit. Since the optical sheet 24 is most tightly or statically fixed in the exemplary embodiment of FIG. 1, it follows that the optical sheet 24 may be significantly crumpled.

In order to verify the extent of deformation of the optical sheet, an exemplary embodiment including all protrusion guide members 26-1 statically fixed to the light guide 10 by the adhesive member 26-2 was formed and the formed structure was stored in a chamber and operated for two hundred and fifty times. As a result, the optical sheet 24 and the reflection sheet 26 of the formed exemplary embodiment are not crumpled. Since the protrusion guide member 26-1 of the reflection sheet 26 includes the same material as a remainder of the reflection sheet 26, the reflection sheet 26 including the protrusion guide member 26-1 may to have an elastic property. When the reflection sheet 26 has the elastic property, a margin is provided within which the optical sheet 24 may move when a portion of the reflective sheet 26 deforms due to the elastic property.

As described above, the optical sheet 24 is sufficiently fixed by the protrusion guide member 26-1 of a same material as the reflection sheet 26 through the above experiments such that a satisfactory fixing performance is verified.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A backlight unit comprising:
a light source which supplies light;
a light guide which transmits the light;
an optical sheet on the light guide, and comprising a fixing member disposed at a side surface of the optical sheet; and
a reflection sheet under the light guide, wherein the reflection sheet reflects the light toward the optical sheet and comprises a protrusion guide member which extends from a side surface of the reflection sheet and toward the light guide,
wherein the fixing member of the optical sheet is coupled to the protrusion guide member of the reflection sheet.

2. The backlight unit of claim 1, wherein
the fixing member of the optical sheet comprises a protrusion guide member extending from the side surface of the optical sheet.

3. The backlight unit of claim 2, wherein
the fixing member of the optical sheet further comprises a groove disposed between the protrusion guide members of the guide member.

4. The backlight unit of claim 1, wherein
a guide member unit restricts the movement of the optical sheet, and comprises one protrusion guide member of the reflection sheet between two fixing members of the optical sheet.

5. The backlight unit of claim 4, wherein
further comprising an adhesive member between a side surface of the light guide and the protrusion guide member of the reflection sheet, wherein the adhesive member couples the light guide and the protrusion guide member to each other.

6. The backlight unit of claim 1, wherein
a guide member unit restricts the movement of the optical sheet, and comprises one fixing member of the optical sheet between two protrusion guide members of the reflection sheet.

7. The backlight unit of claim 6, further comprising
an adhesive member between a side surface of the light guide and the protrusion guide member of the reflection sheet, wherein the adhesive member couples the light guide and the protrusion guide member to each other.

8. The backlight unit of claim 1, further comprising
an adhesive member between a side surface of the light guide and the protrusion guide member of the reflection sheet, wherein the adhesive member couples the light guide and the protrusion guide member to each other.

9. The backlight unit of claim 8, wherein
the reflection sheet further comprises:
a main body, and
a bent portion which connects the protrusion guide member and the main body.

10. The backlight unit of claim 9, wherein the reflection sheet further comprises an opening at the bent portion of the reflection sheet, wherein the protrusion guide member and the main body are separated from each other by the opening.

11. The backlight unit of claim 9, wherein
the main body and the protrusion guide member of the reflection sheet are separated by a predetermined distance.

12. The backlight unit of claim 11, wherein
the protrusion guide member of the reflection sheet includes a same material as the main body and the bent portion of the reflection sheet.

13. The backlight unit of claim 1, wherein
the reflection sheet further comprises a protrusion guide member extension which extends from a distal end of the protrusion guide member, and
the protrusion guide member extension overlaps the light guide.

14. The backlight unit of claim 13, wherein
the protrusion guide member extension overlaps the optical sheet.

15. The backlight unit of claim 14, further comprising
a first adhesive member between a side surface of the light guide and the protrusion guide member of the reflection sheet, wherein the first adhesive member couples the light guide and the protrusion guide member to each other.

16. The backlight unit of claim 15, wherein
the reflection sheet further comprises a protrusion guide member extension, and
further comprising a second adhesive member between an upper surface of the optical sheet and the protrusion guide member extension, and coupling the optical sheet and the protrusion guide member extension to each other.

17. The backlight unit of claim 1, wherein
a guide member unit restricts the movement of the optical sheet, and comprises the protrusion guide member of the reflection sheet and the fixing member of the optical sheet, and
further comprising two guide member units.

18. The backlight unit of claim 17, wherein
one of the two guide member units is at a first side of the light guide, and
the other of the two guide member units is at a second side opposing the first side of the light guide.

19. The backlight unit of claim 18, wherein
the light source is at a side of the light guide excluding the guide member units.

20. The backlight unit of claim 1, wherein the protrusion guide member of the reflection sheet is spaced apart from the side surface of the optical sheet where the guide member is disposed.

21. The backlight unit of claim 1, wherein the protrusion guide member of the reflection sheet contacts the side surface of the optical sheet where the guide member is disposed.
